(19) United States
(12) Patent Application Publication
(10) Pub. No.: US 2024/0413389 A1
(43) Pub. Date: Dec. 12, 2024

(54) SULFIDE-BASED SOLID ELECTROLYTE FOR LITHIUM SECONDARY BATTERY, METHOD FOR PREPARING SAME, AND ELECTRODE COMPRISING SAME

(71) Applicant: Korea University Research and Business Foundation, Seoul (KR)

(72) Inventors: Dong-Wan KIM, Seoul (KR); Seung-Deok SEO, Seoul (KR); Suk-Ho HWANG, Seoul (KR)

(73) Assignee: Korea University Research and Business Foundation, Seoul (KR)

(21) Appl. No.: 18/742,669

(22) Filed: Jun. 13, 2024

Related U.S. Application Data
(63) Continuation of application No. PCT/KR2022/020271, filed on Dec. 13, 2022.

(30) Foreign Application Priority Data
Dec. 13, 2021 (KR) 10-2021-0177387
Dec. 13, 2022 (KR) 10-2022-0173678

(51) Int. Cl. H01M 10/0562; C01G 17/00; H01M 10/0525

(52) U.S. Cl. CPC H01M 10/0562; C01G 17/006; H01M 10/0525; C01P 2006/40; H01M 2300/008

(57) ABSTRACT

The present invention can provide a method for preparing a sulfide-based solid electrolyte in a short time using a solvothermal synthesis method. In addition, the present invention may provide a sulfide-based solid electrolyte prepared by the method. In addition, the present invention may provide an electrode for an all-solid-state battery including the sulfide-based solid electrolyte.

### TECHNICAL FIELD

The present disclosure relates to a method of preparing a sulfide-based solid electrolyte for a lithium secondary battery, a solid electrolyte prepared by the method, and an electrode for an all-solid-state battery including the solid electrolyte, and more particularly, to a method of preparing a sulfide-based solid electrolyte using a solvothermal synthesis method, a solid electrolyte prepared by the method, and use of the solid electrolyte.

### BACKGROUND TECHNOLOGY

Lithium secondary batteries have been applied to small devices such as mobile phones, notebook computers, and the like, but have recently been expanding to medium and large devices such as energy storage devices and electric vehicles. Since a lithium secondary battery uses an organic liquid electrolyte to which a lithium salt is added, the lithium secondary battery has a potential risk of not only leakage of the electrolyte but also ignition and explosion.

Recently, research has been conducted on all-solid-state batteries in which a liquid electrolyte is replaced with a solid electrolyte in order to overcome the limitations of the lithium secondary battery and improve the stability of the battery. The all-solid-state battery has no risk of fire and explosion by using a solid-state electrolyte and has high energy density, and thus, may be used in medium and large devices such as an electric vehicle and a power storage system, like the lithium secondary battery.

Solid electrolytes are divided into an oxide-based solid electrolyte and a sulfide-based solid electrolyte. In particular, the sulfide-based solid electrolyte has excellent lithium ion conductivity compared to the oxide-based solid electrolyte, and has advantages of being stable over a wide voltage range. Sulfide-based solid electrolytes are generally prepared by a melting method or a solid phase method. In particular, in the case of the solid phase method, the starting raw material and balls are put into a milling container, pulverized, and then heat-treated by providing high energy. However, the above method requires a lot of time and energy because it requires high energy. In addition, a low-temperature liquid phase process has been reported, but the longer the synthesis time, the lower the productivity and the lower the purity.

Therefore, there is a need for a novel synthesis method capable of synthesizing a high-purity solid electrolyte with only a small amount of energy in a short time.

### DETAILED DESCRIPTION OF THE INVENTION

### Technical Problems

An object of the present invention is to provide a method for preparing a sulfide-based solid electrolyte at a low temperature using a solvothermal synthesis method.

In addition, another object of the present invention is to provide a sulfide-based solid electrolyte prepared by the method.

In addition, another object of the present invention is to provide an electrode for an all-solid-state battery including the sulfide-based solid electrolyte.

### Technical Solving Method

According to an aspect of the present disclosure, an example of the present invention may include a method of preparing a sulfide-based solid electrolyte for a lithium secondary battery which includes dissolving a first compound including lithium, a second compound including at least one M element, a third compound including at least one chalcogen element, and a fourth compound including at least one halogen element in a polar solvent to prepare a reaction solution; rapidly increasing a temperature of the reaction solution to form a precursor; drying the precursor to remove a residual solvent and select a solid material; and heat-treating the solid material with an inert gas to crystallize the solid material to form an azirodite crystal structure, wherein the M element is at least one of P, Sn, Sb, As, and Ge, and the azirodite crystal satisfies a chemical formula of Equation 1.

LiₐM_{b}A_{c}X_{d} Equation 1

In Equation 1, 5≤a≤7.5, 0.5≤b≤1.5, 4≤c≤6, and 0.5≤d≤2. In Equation 1, M is at least one of P, Sn, Sb, As, and Ge. A is at least one of S, Se, and Te, and X is at least one of Cl, Br, and I.

In an example of the present invention, the argyrodite crystal structure may have peaks at diffraction angles 2θ at 2θ=15°±0.5°, 17.5°±0.5°, 25°±0.5°, 29.5°±0.5°, and 30.9°±0.5° in an XRD spectrum using a CuKα ray, and the peaks at 2θ=15°±0.5° and 17.5°±0.5° may be generated after annealing.

In an example of the present invention, the polar solvent may be polar aprotic, and the polar solvent may include at least one of tetrahydrofuran, acetonitrile, ethyl pentanoate, ethyl acetate, 1,2-dimethoxyethane (1,2-dimethoxyethane), dimethyl carbonate, methyl propyl ketone, N-methylformamide, dimethyl sulfoxide, propylene carbonate, dichloromethane, N-methylmorpholine, 1,2-dimethoxyethane (1,2-dimethoxyethane), acetone, anhydrous hydrazine, pyridine, and anisole.

In an example of the present invention, the precursor formed in the step of forming the precursor may be the compound of Equation 2, and the compound of Equation 2 may be present even after the annealing.

MA₄³⁻ Equation 2

Here, M is at least one of P, Sn, Sb, As and Ge, and A is at least one of S, Se and Te.

In an example of the present invention, in the forming of the precursor, a start temperature may be 0° C. to 50° C., a temperature may be increased at a rate of 20° C./min to 250° C./min, and a final temperature may be 70° C. to 300° C.

In an example of the present invention, the forming of the precursor may be maintained for 1 minute to 12 hours after reaching a final temperature.

In an example of the present invention, in the heat-treating to form the argyrodite crystal structure, the heat-treating may be performed at a starting temperature of 0° C. to 200° C., a temperature is increased at a rate of 2° C./min to 100° C./min, and a final temperature of 400° C. to 600° C.

In an example of the present disclosure, the average particle diameter of the argyrodite crystal may be 0.5 μm to 20 μm.

According to an aspect of the present disclosure, an example of the present disclosure may include a sulfide-based solid electrolyte for a lithium secondary battery, which is a sulfide-based solid electrolyte having at least one of the above features and satisfies the chemical formula of Equation 1.

LiₐM_{b}A_{c}X_{d} Equation 1

In Equation 1, 5≤a≤7.5, 0.5≤b≤1.5, 4≤c≤6, and 0.5≤d≤2. In Equation 1, M is at least one of P, Sn, Sb, As, and Ge. A is at least one of S, Se, and Te, and X is at least one of Cl, Br, and I.

In an example of the present disclosure, the electrical conductivity may be 10⁻¹⁰ S/cm to 10⁻² S/cm.

In an example of the present disclosure, the ionic conductivity may be 10⁻⁹ mS/cm to 20 mS/cm.

In an example of the present disclosure, an XRD spectrum using a CuKα ray may have peaks at diffraction angles 2θ at 2θ=15°±0.5°, 17.5°±0.5°, 25°±0.5°, 29.5°±0.5°, and 30.9°±0.5°, and the peaks at 2θ=15°±0.5° and 17.5°±0.5° may be generated after annealing.

In an example of the present invention, the argyrodite crystal structure may be represented by the following Equation 5, and in an X-ray photoelectron spectroscopy (XPS) analysis of the argyrodite crystal structure after annealing with the precursor, the argyrodite crystal structure may include peaks at 131.8±0.5 (P 2p3/2) and 132.7±0.5 (P 2p1/2) eV, which mean P—S bonds in the PS₄³⁻ structure, in the P 2p spectrum, and peaks at 161.6±0.5 (P 2p3/2) and 162.5±0.5 (P 2p1/2) eV, which mean P—S—Li bonds in the PS₄³⁻ structure, in the S 2p spectrum.

LiₐPS₅X_{d} Equation 5

In Equation 5, 5≤a≤7.5, 0.5≤d≤2, and X are at least any one of Cl, Br, and I.

In an example of the present invention, the argyrodite crystal structure may be represented by the following Equation 6, and ionic conductivity may increase so that b1 may increase.

LiₐP_{(1-b1)}Sn_{b1}S₅X_{d} Equation 6

In Equation 6, 5≤a≤7.5, 0.1≤b1≤1.0, 0.5≤d≤2, and X are at least one of Cl, Br, and I.

In an example of the present invention, the argyrodite crystal structure may be represented by the following Equation 7, and ionic conductivity may increase so that b1 may increase.

LiₐP_{(1-b1)}Ge_{b1}S₅X_{d} Equation 7

In Equation 7, 5≤a≤7.5, 0.1≤b1≤1.0, 0.5≤d≤2, and X are at least any one of Cl, Br, and I.

In an example of the present invention, the argyrodite crystal structure may be represented by the following Equation 8, and ionic conductivity may increase so that b1 may increase.

LiₐSb_{(1-b1)}Ge_{b1}S₅X_{d} Equation 8

In Equation 8, 5≤a≤7.5, 0≤b1≤1.0, 0.5≤d≤2, and X are at least any one of Cl, Br, and I.

### Effects of the Invention

The present invention can provide a method for preparing a sulfide-based solid electrolyte in a short time using a solvothermal synthesis method.

In addition, the present invention may provide a sulfide-based solid electrolyte prepared by the method.

In addition, the present invention may provide an electrode for an all-solid-state battery including the sulfide-based solid electrolyte.

### BRIEF DESCRIPTION OF DRAWINGS

FIG. 1 is a view illustrating a method of preparing a sulfide-based solid electrolyte according to an example of the present invention.

FIG. 2 is a diagram obtained by analyzing a precursor prepared in Example 1-1 of the present invention.

FIG. 3 shows a comparison of XRD analysis of the precursor prepared in Example 1-1 of the present invention and the precursor prepared by the conventional low temperature liquid synthesis method.

FIG. 4 shows an analysis of the properties of the precursor prepared in Example 1-1 of the present invention and argyrodite crystals.

FIGS. 5 and 6 illustrate a comparison between the precursor prepared in Example 1-1 of the present invention and cases prepared by elemental distribution and low miscibility of argyrodite crystals.

FIG. 7 shows an analysis of the properties of the precursor prepared in Example 1-1 of the present invention and argyrodite crystals.

FIGS. 8 to 11 illustrate the results of analyzing the electrochemical properties of a solid electrolyte in Example 1-1 of the present invention and comparing the results with those prepared by low-temperature synthesis.

FIG. 12 is a view showing whether a precursor is formed according to a precursor formation temperature in Examples 1-2 to 1-4 of the present invention.

FIG. 13 illustrates analysis of electrochemical characteristics of the precursor prepared in Example 1-4 of the present invention, the crystal of argyrodite, and the solid electrolyte.

FIG. 14 shows an analysis of the electrochemical characteristics of the precursor prepared in Example 1-5 of the present invention, the crystal of argyrodite, and the solid electrolyte.

FIG. 15 shows analysis of the precursor and argyrodite crystals prepared in Example 2 of the present invention.

FIG. 16 is an analysis of electrochemical characteristics of the solid electrolyte prepared in Example 2 of the present invention.

FIG. 17 illustrates analysis of characteristics of precursors, argyrodite crystals, and solid electrolytes prepared in Examples 3-1 to 3-3 of the present invention.

FIG. 18 shows analysis of characteristics of argyrodite crystals and a solid electrolyte prepared in Example 3-4 of the present invention.

FIG. 19 shows analysis of characteristics of argyrodite crystals and solid electrolytes prepared in Examples 3-5 and 3-6 of the present invention.

### MODE FOR INVENTION

Details of other examples are included in the detailed description and the drawings.

Advantages and features of the present disclosure, and methods of achieving the advantages and features will become apparent with reference to examples described below in detail in conjunction with the accompanying drawings. However, the present invention is not limited to the examples disclosed below, but may be implemented in various different forms, and unless otherwise specified in the following description, all numbers, values, and/or expressions representing components, reaction conditions, and contents of components in the present invention should be understood to be modified by the term “about” in all cases, as these numbers are essentially approximations reflecting various uncertainties in the measurement occurring in obtaining such values among others. In addition, when a numerical range is disclosed in the present disclosure, the range is continuous, and unless otherwise indicated, the range includes all values from the minimum value of the range to the maximum value including the maximum value. The invention further relates to the inclusion of all integers, including from the minimum value to the maximum value including the maximum value, unless otherwise indicated, when such a range refers to an integer

In addition, in the present disclosure, when a range is described for a variable, it will be understood that the variable includes all values within the described range including the described end points of the range. For example, it will be understood that a range of “5 to 10” includes not only the values of 5, 6, 7, 8, 9, and 10, but also any sub-ranges such as 6 to 10, 7 to 10, 6 to 9, 7 to 9, etc., and also includes any values between integers valid within the scope of the described ranges such as 5.5, 6.5, 7.5, 5.5 to 8.5, 6.5 to 9, etc. For example, it will be understood that a range of “10% to 30%” includes not only values of 10%, 11%, 12%, 13%, etc. and all integers including up to 30%, but also any sub-range of 10% to 15%, 12% to 18%, 20% to 30%, etc., and also includes any value between valid integers within the scope of the range described, such as 10.5%, 15.5%, 25.5%, etc.

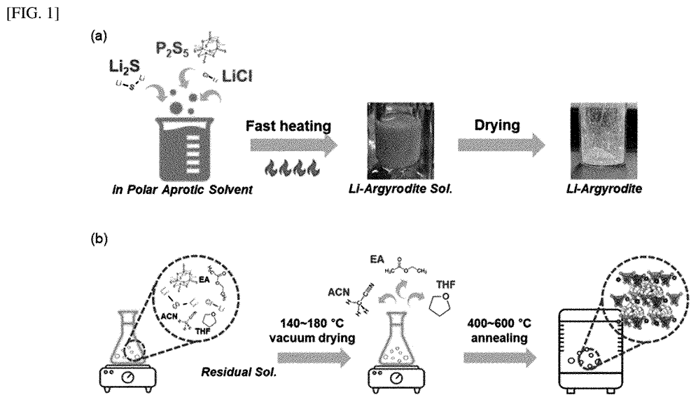

FIG. 1 is a schematic diagram illustrating a process of preparing a sulfide-based solid electrolyte according to an example of the present invention. In FIG. 1, (a) shows a process of forming a precursor, and (b) shows a process of preparing a solid electrolyte by forming an argyrodite crystal through heat treatment (annealing).

According to an aspect of the present disclosure, a method for preparing a sulfide-based solid electrolyte for a lithium secondary battery may include dissolving a first compound containing lithium, a second compound containing one or more M elements, a third compound containing one or more chalcogen elements, and a fourth compound containing one or more halogen elements in a polar solvent to prepare a reaction solution; rapidly raising the temperature of the reaction solution to form a precursor; drying the precursor to remove the residual solvent and select a solid material; and heat-treating the solid material with an inert gas to crystallize the solid material to form an argyrodite crystal structure, wherein the M element is at least one of P (phosphorus), Sn (tin), Sb (antimony), As (arsenic), and Ge (germanium).

The first compound, the second compound, the third compound, and the fourth compound may be dissolved while being stirred in the polar solvent, and the dissolving time may be performed for 1 minute to 30 minutes. The second compound, the third compound, and the fourth compound may each include one or more elements, and may be included at different ratios depending on the type of the solid electrolyte to be prepared.

The sulfide-based solid electrolyte may satisfy the chemical formula of Equation 1.

LiₐM_{b}A_{c}X_{d} Equation 1

In Equation 1, 5≤a≤7.5, 0.5≤b≤1.5, 4≤c≤6, and 0.5≤d≤2. In Equation 1, M is at least one of P, Sn, Sb, As, and Ge. A is at least one of S, Se, and Te, and X is at least one of Cl, Br, and I.

The M element included in the second compound may include at least one of P (phosphorus), Sn (tin), Sb (antimony), As (arsenic), and Ge (germanium). The ionic conductivity, electrical conductivity, and battery characteristics of the battery may be changed by adjusting the type and ratio of the M element.

The chalcogen element included in the third compound may be at least one of sulfur (S), selenium (Se), and tellurium (Te). The ionic conductivity, electrical conductivity, and battery characteristics of the battery may be changed by adjusting the type and ratio of the cation-forming element.

The halogen element included in the fourth compound may be at least one of Cl (chlorine), Br (bromine), and I (iodine).

The polar solvent may be a polar aprotic solvent. The polar solvent may include, for example, at least one of tetrahydrofuran, acetonitrile, ethyl pentanoate, ethyl acetate, 1,2-dimethoxyethane (1,2-dimethoxyethane), dimethyl carbonate, methyl propyl ketone, N-methylformamide, dimethyl sulfoxide, propylene carbonate, dichloromethane, N-methylmorpholine, 1,2-dimethoxyethane (1,2-dimethoxyethane), acetone, anhydrous hydrazine, pyridine, and anisole, but is not limited thereto.

The argyrodite crystal structure may have peaks at diffraction angles 2θ at 2θ=15°±0.5°, 17.5°±0.5°, 25°±0.5°, 29.5°±0.5°, and 30.9°±0.5° in an XRD spectrum using a CuKα ray, and the peaks at 2θ=15°±0.5° and 17.5°±0.5° may be generated after heat treatment. Therefore, the peaks of 2θ=15°±0.5° and 17.5°±0.5° may be newly generated in the process of growing the solid material of the precursor into an argyrodite crystal structure by heat treatment. Accordingly, it can be confirmed that the azirodite crystal is grown from the precursor.

The precursor formed in the step of forming the precursor may be the compound of Equation 2, and the compound of Equation 2 may be present even after the heat treatment.

MA₄³⁻ Equation 2

In Equation 2, M may be at least one of P, Sn, Sb, As, and Ge, and A may be at least one of S, Se, and Te.

The second compound may be a compound including an M element. The second compound may be represented by Equation 3, and may be, for example, at least one of P₂S₅, Sb₂S₅, Sb₂S₃, GeS₂, GeS, SnS₂, As₂S₅, As₂S₃, P₂Se₅, P₂Se₃, P₂Te₅, and P₂Te₃, but is not limited thereto. At least one of S, Se, and Te may be added to adjust a stoichiometric ratio depending on the type of the second compound.

MₓA_{y} Equation 3

In Equation 3, 1≤x≤2 and 1≤y≤5. In Equation 3, M may be at least one of P, Sn, Sb, As, and Ge, and A may be at least one of S, Se, and Te.

The third compound may be a compound including a chalcogen element. The third compound may be represented by sulfur (S), selenium (Se), tellurium (Te), or Equation 4, and may be, for example, at least one of Li₂S, Li₂Se, and Li₂Te, but is not limited thereto. At least one of S, Se, and Te may be added to adjust a stoichiometric ratio depending on the type of the third compound.

Li₂A Equation 4

In Equation 4, A may be at least one of S, Se, and Te.

The fourth compound may include, for example, at least one of lithium bromide (LiBr), lithium chloride (LiCl), and lithium iodide (LiI), but is not limited thereto.

The reaction solution may be rapidly heated to form a precursor of an argyrodite crystal. The rapid temperature increase of the reaction solution to form the precursor of the argyrodite crystal may be, for example, synthesis by a solvothermal synthesis method. The rapid temperature raising process may be performed by using a device capable of rapidly raising the temperature of the reaction solution, such as a microwave reactor, a convection oven, or the like, without limitation. In addition, the rapid temperature raising process may be performed in a state in which there is no contact with air and moisture by sealing the reactor.

The step of forming the precursor may be to rapidly increase the temperature by setting a starting temperature of 0 to 50° C.

The rapid temperature increase may be, for example, a temperature increase at a rate of 20° C./min to 250° C./min. In addition, the rapid temperature increase may be, for example, a temperature increase at a rate of 20° C./min to 200° C./min. In addition, the rapid temperature increase may be, for example, a temperature increase at a rate of 100° C./min to 200° C./min.

The final temperature after the rapid temperature increase may be, for example, 70° C. to 300° C. In addition, the final temperature after the rapid temperature increase may be, for example, 100° C. to 200° C. In addition, the final temperature after the rapid temperature increase may be, for example, 150° C. to 250° C.

In the forming of the precursor, the final temperature may be maintained, for example, for 1 minute to 12 hours after reaching the final temperature. In addition, the final temperature may be maintained, for example, for 10 minutes to 3 hours.

The start temperature, the rapid rising temperature, the final temperature, and the final temperature holding time are appropriately performed, so that the precursor may be stably formed.

In the step of heat-treating to form an argyrodite crystal structure, the heat-treating may start at 0 to 200° C. The heat treatment may be to raise the temperature at a rate of, for example, 2° C./min to 100° C./min. In addition, the final temperature of the heat treatment may be performed at 400° C. to 600° C.

By the heat treatment conditions as described above, argyrodide crystals may be stably formed and advantageous properties as a solid electrolyte may be exhibited.

The argyrodite crystal may have an average particle diameter of 0.5 μm to 20 μm.

The solid electrolyte prepared by the method of preparing a sulfide-based solid electrolyte for a lithium ion battery may include a sulfide-based solid electrolyte for a lithium secondary battery satisfying the formula of Equation 1.

LiₐM_{b}A_{c}X_{d} Equation 1

In Equation 1, 5≤a≤7.5, 0.5≤b≤1.5, 4≤c≤6, and 0.5≤d≤2. In Equation 1, M may be at least one of P, Sn, Sb, As, and Ge. A may be at least one of S, Se, and Te, and X may be at least one of Cl, Br, and I.

The M element may include at least one of P, Sn, Sb, As, and Ge. The ionic conductivity, electrical conductivity, and battery characteristics of the battery may be changed by adjusting the type and ratio of the cation-forming element.

The chalcogen element may be at least one of S, Se, and Te. The ionic conductivity, electrical conductivity, and battery characteristics of the battery may be changed by adjusting the type and ratio of the cation-forming element.

The halogen element may be at least one of Cl, Br, and I.

The electrical conductivity of the sulfide-based solid electrolyte may be, for example, 10-10 S/cm to 10-2 S/cm. In addition, the electrical conductivity of the sulfide-based solid electrolyte may be, for example, 10⁻⁷ S/cm to 10⁻³ S/cm.

The ionic conductivity of the sulfide-based solid electrolyte may be, for example, 10⁻¹⁰ mS/cm to 20 mS/cm. In addition, the ionic conductivity of the sulfide-based solid electrolyte may be, for example, 10⁻³ mS/cm to 15 mS/cm.

In an example of the present invention, an XRD spectrum using a CuKα ray may have peaks at diffraction angles 2θ at 2θ=15°±0.5°, 17.5°±0.5°, 25°±0.5°, 29.5°±0.5°, and 30.9°±0.5°, and the peaks at 2θ=15°±0.50 and 17.5°±0.5° may be generated after heat treatment.

In an example of the present invention, the azirodite crystal structure may be represented by the following Equation 5, and in an X-ray photoelectron spectroscopy (XPS) analysis of the azirodite crystal structure after heat treatment with the precursor, the azirodite crystal structure may include peaks at 131.8±0.5 (P 2p3/2) and 132.7±0.5 (P 2p1/2) eV, which mean P—S bonds in the PS₄³⁻ structure, in the P 2p spectrum, and peaks at 161.6±0.5 (P 2p3/2) and 162.5±0.5 (P 2p1/2) eV, which mean P—S—Li bonds in the PS₄³⁻ structure, in the S 2p spectrum.

LiₐPS₅X_{d} Equation 5

In Equation 5, 5≤a≤7.5, 0.5≤d≤2, and X are at least any one of Cl, Br, and I.

In an example of the present invention, the argyrodite crystal structure may be represented by the following Equation 6, and ionic conductivity may increase so that b1 may increase.

LiₐP_{(1-b1)}Sn_{b1}S₅X_{d} Equation 6

In Equation 6, 5≤a≤7.5, 0.5≤d≤2, and X may be at least one of Cl, Br, and I. In addition, in Equation 8, b1 may have a range of 0.1≤b1≤1.0. In addition, in Equation 8, b1 may have a range of 0≤b1≤0.2.

In an example of the present invention, the argyrodite crystal structure may be represented by the following Equation 7, and the ion conductivity may increase as b1 increases.

LiₐP_{(1-b1)}Ge_{b1}S₅X_{d} Equation 7

In Equation 7, 5≤a≤7.5, 0.5≤d≤2, and X may be at least one of Cl, Br, and I. In addition, in Equation 7, b1 may have a range of 0.1≤b1≤1.0. In addition, in Equation 8, b1 may have a range of 0≤b1≤0.2.

In an example of the present invention, the argyrodite crystal structure may be represented by the following Equation 8, and ionic conductivity may increase so that b may increase.

LiₐSb_{(1-b1)}Ge_{b1}S₅X_{d} Equation 8

In Equation 8, 5≤a≤7.5, 0.5≤d≤2, and X may be at least one of Cl, Br, and I. In addition, in Equation 8, b1 may have a range of 0≤b1≤1.0. In addition, in Equation 8, b1 may have a range of 0≤b1≤0.2.

The sulfide-based solid electrolyte for a lithium ion battery may have, for example, the following chemical formulas in addition to Equations 1, 4 to 8 above.

For example, the sulfide-based solid electrolyte for a lithium ion battery may have a chemical formula of Li₆PS₅I, Li₆PS₅Br, Li₆SbS₅I, Li₆SbS₅I_{0.5}Br_{0.5}, Li₆SbS₅Cl_{0.5}Br_{0.5}, Li₆SbS₅Cl_{0.5}I_{0.5}, Li_{5.5}PS_{4.5}Cl_{1.5}, Li_{5.5}SbS_{4.5}Cl_{1.5}, Li_{5.5}PS_{4.5}Br_{1.5}, Li_{5.5}SbS_{4.5}Br_{1.5}, Li_{5.5}PS_{4.5}I_{1.5}, Li_{5.5}SbS_{4.5}I_{1.5}, Li₆PTe₅I, Li₆PTe₅Br, Li₆SbTe₅I.

In addition, for example, the sulfide-based solid electrolyte for a lithium ion battery may have a chemical formula of Li_{6.4}P_{0.6}Sn_{0.4}S₅I, Li_{6.1}P_{0.9}Sn_{0.1}S₅Br, Li_{6.05}P_{0.95}Sn_{0.05}S₅Cl, Li_{6.1}P_{0.9}Sn_{0.1}S₅I_{0.9}Br_{0.1}, Li_{6.1}P_{0.9}Sn_{0.1}S₅I_{0.8}Br_{0.2}, Li_{6.1}P_{0.9}Sn_{0.1}S₅I_{0.9}Cl_{0.1}, Li_{6.1}P_{0.9}Sn_{0.1}S₅I_{0.2}Cl_{0.2}, Li_{6.1}P_{0.9}Sn_{0.1}S_{2.5}Se_{2.5}I_{0.9}Br_{0.1}, Li_{6.1}P_{0.9}Sn_{0.1}S_{2.5}Te_{2.5}I_{0.9}Br_{0.1}, Li_{6.4}P_{0.6}Sn_{0.4}Se₅I, Li_{6.1}P_{0.9}Sn_{0.1}Se₅Br, Li_{6.05}P_{0.95}Sn_{0.05}Se₅Cl, Li_{6.4}P_{0.6}Sn_{0.4}Te₅I, Li_{6.1}P_{0.9}Sn_{0.1}Te₅Br, Li_{6.05}P_{0.95}Sn_{0.05}Te₅Cl, Li_{5.6}P_{0.9}Sn_{0.1}S_{4.5}I_{1.5}, Li_{5.7}P_{0.8}Sn_{0.2}S_{4.5}I_{1.5}, Li_{5.7}P_{0.8}Sn_{0.2}S_{2.5}Se_{2.0}I_{1.5}.

In addition, for example, the sulfide-based solid electrolyte for a lithium ion battery may have a chemical formula of Li_{6.8}P_{0.2}Ge_{0.8}S₅I, Li_{6.2}P_{0.8}Ge_{0.2}S₅I, Li_{6.3}P_{0.7}Ge_{0.3}S₅I, Li_{6.4}P_{0.6}Ge_{0.4}S₅I Li_{6.2}P_{0.8}Ge_{0.2}S₅Br, Li_{6.05}P_{0.95}Ge_{0.05}S₅Cl, Li_{6.1}P_{0.9}Ge_{0.1}S₅I_{0.9}Br_{0.1}, Li_{6.1}P_{0.9}Ge_{0.1}S₅I_{0.8}Br_{0.2}, Li_{6.1}P_{0.9}Ge_{0.1}S₅I_{0.9}Cl_{0.1}, Li_{6.1}P_{0.9}Ge_{0.1}S₅I_{0.8}Cl_{0.2}, Li_{6.1}P_{0.9}Ge_{0.1}S_{2.5}Se_{2.5}I_{0.9}Br_{0.1}, Li_{6.1}P_{0.9}Ge_{0.1}S_{2.5}Te_{2.5}I_{0.9}Br_{0.1}, Li_{6.4}P_{0.6}Ge_{0.4}Se₅I, Li_{6.1}P_{0.9}Ge_{0.1}Se₅Br, Li_{6.05}P_{0.95}Ge_{0.05}Se₅Cl, Li_{6.4}P_{0.6}Ge_{0.4}Te₅I, Li_{6.1}P_{0.9}Ge_{0.1}Te₅Br, Li_{6.05}P_{0.95}Ge_{0.05}Te₅Cl, Li_{5.6}P_{0.9}Ge_{0.1}S_{4.5}I_{1.5}, Li_{5.7}P_{0.8}Ge_{0.2}S_{4.5}I_{1.5}, Li_{5.7}P_{0.8}Ge_{0.2}S_{2.5}Se_{2.0}I1_{1.5}, Li_{6.8}Sb_{0.2}Ge_{0.8}S₅I, Li_{6.2}Sb_{0.8}Ge_{0.2}S₅I, Li_{6.3}Sb_{0.7}Ge_{0.3}S₅I, Li_{6.4}Sb_{0.6}Ge_{0.4}S₅I Li_{6.2}Sb_{0.8}Ge_{0.2}S₅Br, Li_{6.05}Sb_{0.95}Ge_{0.05}S₅Cl, Li_{6.1} Sb_{0.9}Ge_{0.1}S₅I_{0.9}Br_{0.1}, Li_{6.1} Sb_{0.9}Ge_{0.1}S₅I_{0.8}Br_{0.2}, Li_{6.1} Sb_{0.9}Ge_{0.1}S₅I_{0.9}Cl_{0.1}, Li_{6.1}Sb_{0.9}Ge_{0.1}S₅I_{0.8}Cl_{0.2}, Li_{6.1}Sb_{0.9}Ge_{0.1}S_{2.5}Se_{2.5}I_{0.9}Br_{0.1}, Li_{6.1}Sb_{0.9}Ge_{0.1}S_{2.5}Te_{2.5}I_{0.9}Br_{0.1}, Li_{6.4}Sb_{0.6}Ge_{0.4}Se₅I, Li_{6.1}Sb_{0.9}Ge_{0.1}Se₅Br, Li_{6.05}Sb_{0.95}Ge_{0.5}Se₅Cl, Li_{6.4}Sb_{0.6}Ge_{0.4}Te₅I, Li_{6.1}Sb_{0.9}Ge_{0.1}Te₅Br, Li_{6.05}Sb_{0.95}Ge_{0.05}Te₅Cl, Li_{5.6}Sb_{0.9}Ge_{0.1}S_{4.5}I_{1.5}, Li_{5.7}Sb_{0.8}Ge_{0.2}S_{4.5}I_{1.5}, Li_{5.7}Sb_{0.8}Ge_{0.2}S_{2.5}Se_{2.0}I1_{1.5}.

Hereinafter, Examples and Comparative Examples of the present invention will be described. However, the following Examples are only preferred examples of the present invention, and the scope of the present invention is not limited by the following Examples.

### Example 1

1. High-Speed Optical Disk. The Synthesis of Azirodite Precursors

Li₂S, P₂S₅, and LiX powder were mixed with acetonitrile (ACN) in a molar ratio of 5:1:2, and dispersed at 25° C. for about 1 minute using a magnetic stirrer to prepare a reaction solution. As LiX, LiCl or LiI was used depending on the halogen element. The reaction solution was placed in a reactor capable of irradiating microwaves (maximum output: ˜850 W, maximum frequency: ˜2455 MHz.), and the inside of the reactor was filled with argon (Ar) gas, and then irradiated with microwaves to rapidly raise the temperature. The temperature increase was carried out at a rate of 200° C./min, and after reaching the final temperature, the final temperature was maintained for a certain period of time so that the precursor was well formed. Then, it was transferred into a glove box and vacuum-dried. Then, in order to remove the residual solvent of the precursor, the precursor was vacuum-dried once more while maintaining a temperature of 140˜180° C. using a hot plate and a flat bottom flask.

### 2. Crystallization of Argyrodite

The argyrodite precursor was put in a quartz tube filled with Ar gas and sealed, and then heat treatment (annealing) was performed at about 550° C. for 5 hours using an electric furnace. As a result of the heat treatment, crystals of an argyrodite structure were formed to prepare a solid electrolyte.

3. Manufacturing an all-Solid-State Battery

A positive electrode for an all-solid-state battery was prepared using the solid electrolyte containing the prepared argyrodite crystals as an electrolyte. A cathode active material, a solid electrolyte, and a conductive agent were mixed in a weight ratio of 7:3:0.3 and subjected to cold pressing to prepare a cathode pellet. The cathode active material uses NCM622 (Single-crystal LiNi_{0.6}Co_{0.2}Mn_{0.2}O₂), the solid electrolyte was the solid electrolyte prepared in Example 2, and Super P carbon black was used as the conductive agent. An anode electrode was manufactured by cold pressing lithium powder to prepare a pellet.

Examples according to the type of azirodite crystals are shown in Table 1.

TABLE 1

| | LiX | Precursor synthesis | Chemical formula of |
|---|---|---|---|
| | types | conditions | argyrodite crystals |
| Example 1-1 | LiCl | Rapid rising temperature: | Li₆PS₅Cl |
| | | 200° C. Final temperature | |
| | | holding time: 3 hours | |
| Example 1-2 | LiCl | Rapid rising temperature: | Li₆PS₅Cl |
| | | 100° C. Final temperature | |
| | | holding time: 10 minutes | |
| Examples 1-3 | LiCl | Rapid rising temperature: | Li₆PS₅Cl |
| | | 150° C. Final temperature | |
| | | holding time: 10 minutes | |
| Examples 1-4 | LiCl | Rapid rising temperature: | Li₆PS₅Cl |
| | | 200° C. Final temperature | |
| | | holding time: 10 minutes | |
| Examples 1-5 | LiI | Rapid rising temperature: | Li₆PS₅Cl |
| | | 200° C. Final temperature | |
| | | holding time: 3 hours | |

### Example 2

Example 2 was prepared in the same manner as in Example 1-1 except that the polar aprotic solvent was changed to tetrahydrofuran (THF).

### Example 3

In the argyrodite crystal of Example 1-1, elements of phosphorus (P), sulfur (S), or chlorine (Cl) sites were substituted to prepare argyrodite crystals having various combinations, and the results are shown in Table 2.

In the step of synthesizing the argyrodite precursor, the ratio and amount of each compound were varied and added. The heat treatment conditions in Example 3 were carried out at 450° C. for 5 hours, and the rest was prepared in the same manner as in Example 1-1.

TABLE 2

| | | First M | Second M | Chalcogen | Halogen | |
|---|---|---|---|---|---|---|
| | Lithium | element | element | element | element | |
| | content | content | content | content | content | Chemical |
| | (wt %) | (wt %) | (wt %) | (wt %) | (wt %) | formula |
| Example | 11.5 | 3.2 | 7.5 | 43.4 | 34.4 | Li_{6.1}Sn_{0.1}P_{0.9}S₅I |
| 3-1 | | | | | | |
| Example | 11.4 | 6.3 | 6.5 | 42.3 | 33.5 | Li_{6.2}Sn_{0.2}P_{0.8}S₅I |
| 3-2 | | | | | | |
| Example | 11.3 | 9.2 | 5.6 | 41.3 | 32.7 | Li_{6.3}Sn_{0.3}P_{0.7}S₅I |
| 3-3 | | | | | | |
| Example | 11.7 | 9.5 | 4.0 | 41.7 | 33.0 | Li_{6.5}Ge_{0.5}P_{0.5}I |
| 3-4 | | | | | | |
| Example | 11.2 | x | 11.5 | 43.1 | 34.1 | Li₆SbS₅I |
| 3-5 | | | | | | |
| Example | 11.3 | 1.9 | 10.3 | 42.7 | 33.8 | Li_{6.1}Ge_{0.1}Sb_{0.9}S₅I |
| 3-6 | | | | | | |

Characteristics of the argyrodite precursor prepared in the above Example, argyrodite crystals, and a solid electrolyte and an all-solid-state battery including the same were analyzed.

### Experimental Example 1

Properties of the solid electrolyte and the all-solid-state battery prepared in Example 1 were analyzed.

### 1. Example 1-1

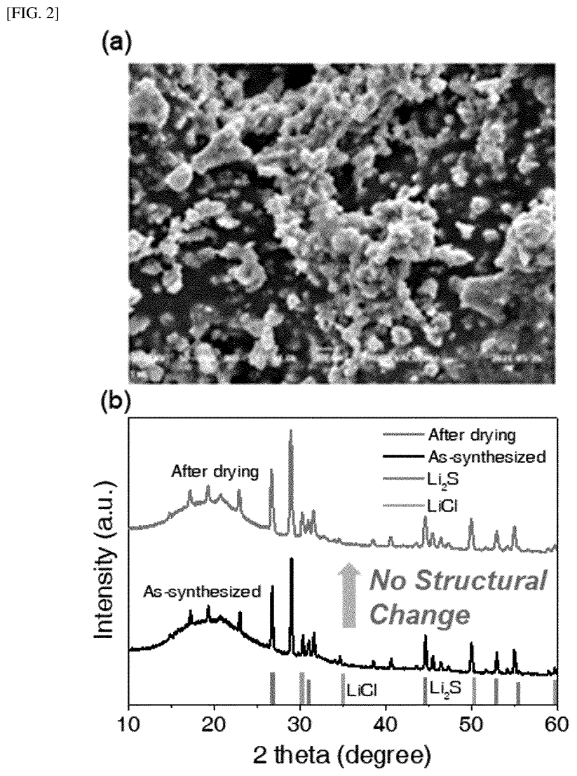

FIG. 2 shows scanning electron microscope (SEM) and X-ray diffraction analysis (XRD) results of a precursor. FIG. 2(a) is an SEM image of the precursor, and it can be confirmed that precursor lumps are formed. FIG. 2(b) shows the results of XRD analysis of the precursor, and it can be confirmed that there is little change in peaks immediately after synthesis of the precursor and after drying.

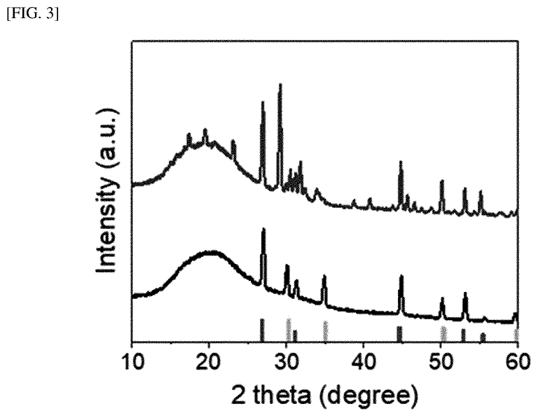

FIG. 3 shows a comparison of XRD peaks of an argyrodite precursor (below) synthesized by a low temperature liquid synthesis method according to the related art and a precursor synthesized by an example (above) of the present invention. In the case of the present invention, 14.9, 17.14, 19.26, 22.92, 30.27, 31.56, and 38.4 peaks were found at 20, which is different from the case of the low temperature liquid synthesis method. Due to such a difference, the present example improves ion conductivity by increasing the site disorders of the halogen ions and the chalcogen ions. In addition, co-crystallization between the precursor and the solvent is reduced, thereby preventing an unintended decrease in ionic conductivity and an increase in electrical conductivity due to undesired by-products.

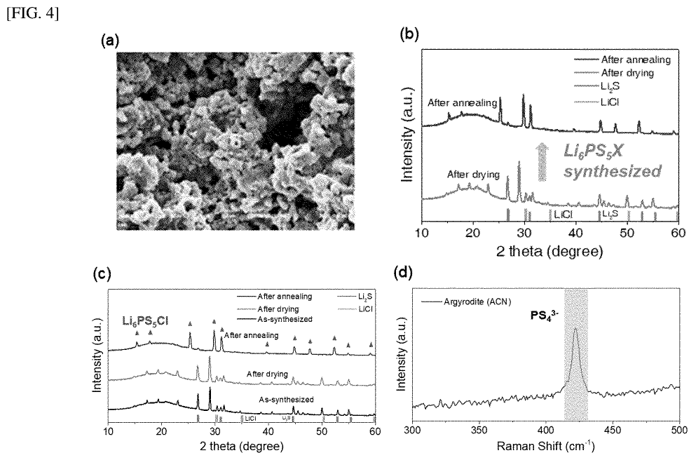

FIG. 4 is a result of analyzing argyrodite crystals formed after heat treatment. FIG. 4(a) is a SEM image of an argyrodite crystal formed by heat-treating a precursor, and it can be confirmed that the size of the crystal is grown compared to the SEM image of FIG. 2. FIGS. 4(b) and (c) show comparison of XRD peaks before and after heat treatment. It can be confirmed that the peak immediately after synthesis and the peak after drying are almost the same as the peak in the precursor step, but it can be confirmed that crystallization proceeds further after annealing (heat treatment), so that there is a difference in peaks. In addition, after the annealing, peaks of 14.3, 19.2, 27, and 28.9 appeared at 26, and it can be confirmed that the azirodite structure was stably formed. FIG. 4D shows the results of Raman analysis of argyrodite crystals, and it can be confirmed that PS₄³⁻ of a tetrahedra structure exists in the argyrodite structure at a strong peak around 419 cm⁻¹.

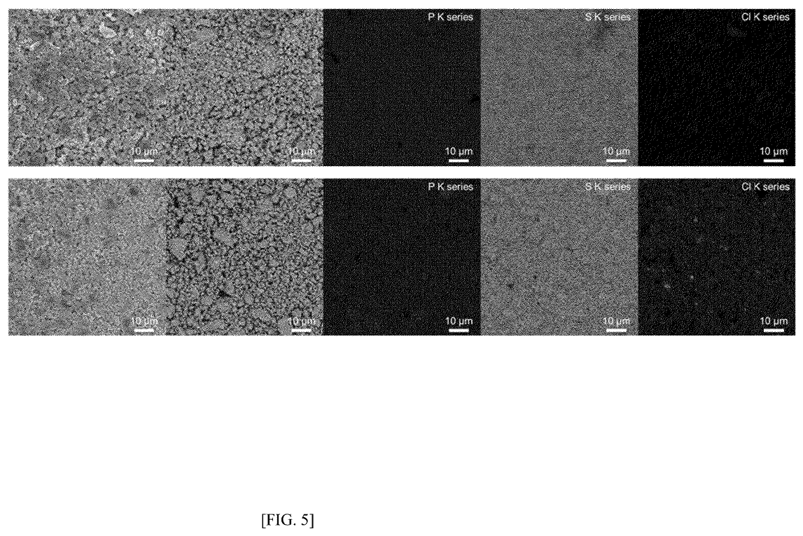

FIG. 5 is an image for confirming the distribution of each element in a precursor (above) and an argyrodite crystal (below) after heat treatment. In the image of the precursor, the elements were evenly distributed, so that a separate starting material was not seen without participating in the reaction. It can be confirmed that even after the argyrodite crystal is formed by heat treatment, the original particles are uniform and the elements are uniformly distributed.

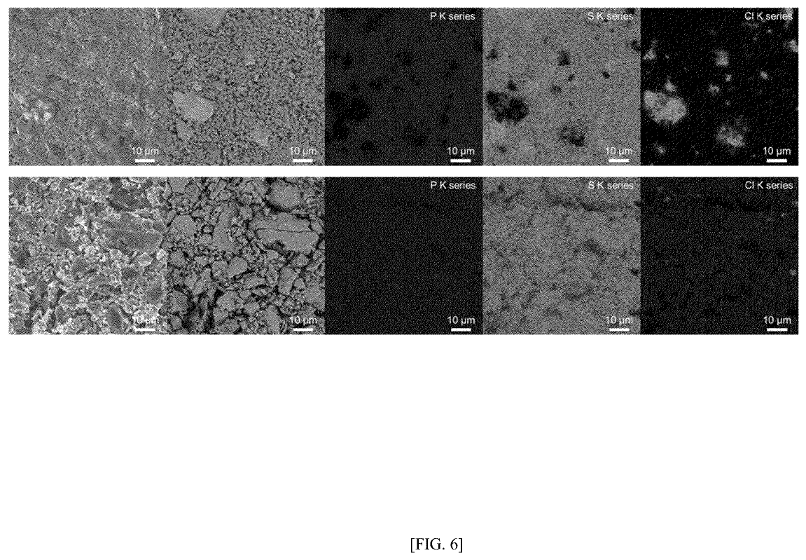

FIG. 6 is an image showing that a precursor (top) and an argyrodite crystal (bottom) were prepared by a low temperature synthesis method and the distribution of each element was confirmed. In this case, unlike FIG. 5, it was confirmed that a starting material (LiCl) that did not participate in the reaction was seen in the precursor, and it was confirmed that the particle size of the argyrodite crystal was large and was not uniform even after the heat treatment.

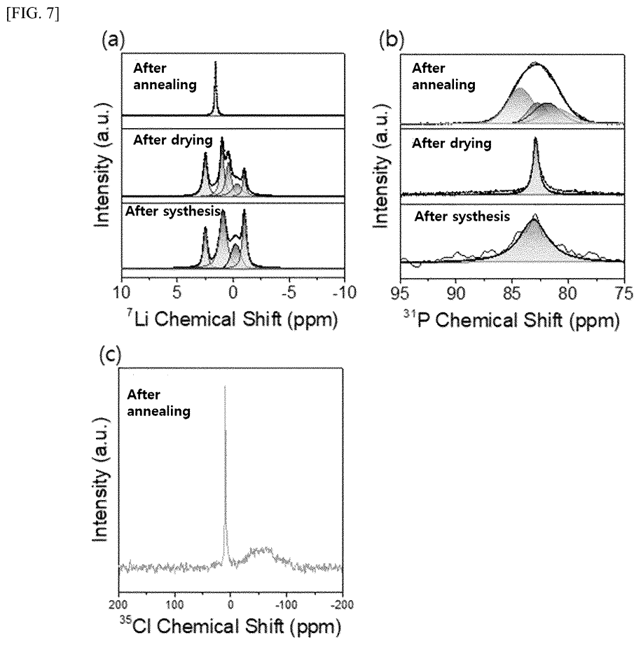

FIG. 7 shows measurement of Raman spectroscopy and X-ray photoelectron spectroscopy (XPS) at each step in the process of forming an argyrodite crystal. In FIG. 7(a), it can be confirmed that a peak of the PS₄³⁻ structure, which becomes a parent of the azirodite crystal, appears immediately after synthesis (that is, after formation of the precursor), and it can be confirmed that this peak is maintained after the precursor is preformed and after heat treatment. FIG. 7(b) shows the XPS result at P 2p, and peaks were observed at 131.8 (P 2p_{3/2}) and 132.7 (P 2p_{1/2}) eV immediately after synthesis (i.e., after precursor formation), and these peaks were maintained after drying and after heat treatment. This peak means P—S bond in the PS43-structure and supports the Raman spectroscopy results. The peaks found at 133.1 and 134 eV in FIG. 7(b) are due to oxidized phosphorus species (P2SX). FIG. 7(c) shows the XPS result at S 2p, peaks were observed at 161.6 (P 2p_{3/2}) and 162.5 (P 2p_{1/2}) eV immediately after synthesis, and these peaks were maintained after drying and after heat treatment. This means P—S—Li bond. The peaks found at 163.4 and 164.5 eV in FIG. 7(c) are due to oxidized sulfur species (binding of P—S—S—P in P₂S₆²⁻). FIG. 7(d) is a In-situ Raman analysis result of measuring the time taken to form the PS₄³ structure, and it can be confirmed that the PS₄³ structure is formed about 1 minute after raising the temperature to 200° C.

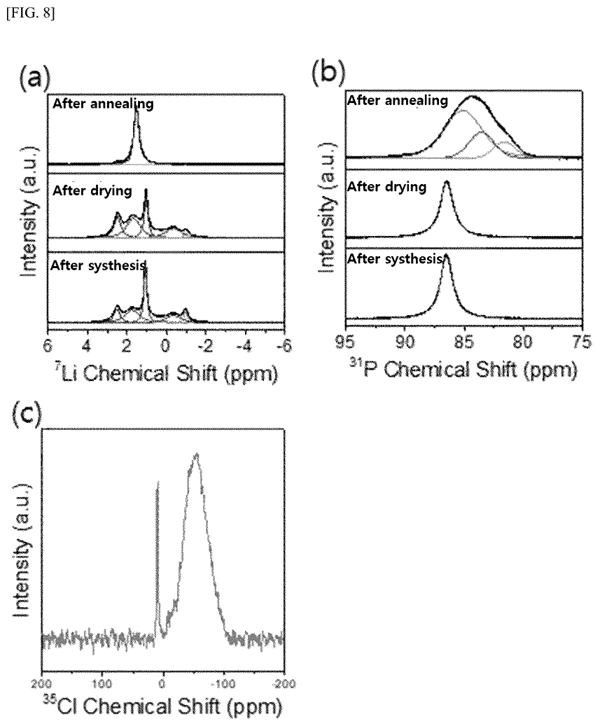

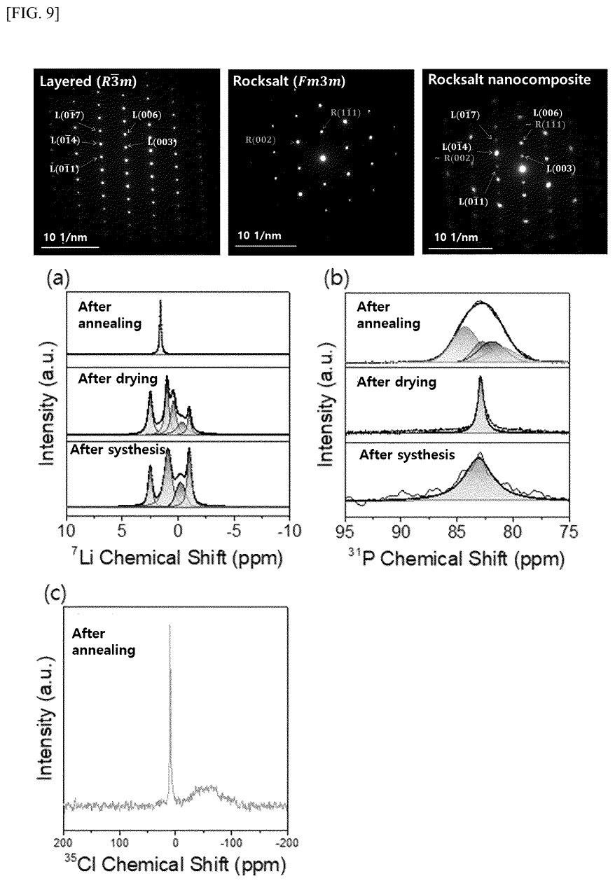

FIG. 8 shows a result of measuring a state of each step in a process of forming an argyrodite crystal by solid-state NMR. FIG. 8(a) is a result of measuring ⁷Li MAS NMR, and peaks appeared at about 2.5, 1.7, 1.08, −0.35, and −0.99 ppm immediately after synthesis (i.e., after precursor formation), and peaks appearing at 1.08 and −0.35 ppm mean that Cl ions (halogen ions) are included in the precursor crystal structure. In addition, after the heat treatment, a peak was found at about 1.53 ppm, which means that argyrodite crystals were formed. FIG. 8(b) shows the results of measuring ³¹P MAS NMR, and it can be confirmed that a peak of about 86.6 ppm appears immediately after synthesis (that is, after formation of the precursor), and thus the PS₄³ structure is formed. In addition, the peaks at about 85.1, 83.6, and 81.6 ppm after the heat treatment mean that a structure corresponding to PS₃Cl²⁻, PS₂Cl²¹⁻ and PSCl³ is formed. This peak means that the S²⁻/Cl⁻ ion is substituted after heat treatment. In addition, FIG. 8(c) is a result of measuring ³⁵Cl MAS NMR, and it can be confirmed that peaks are found around about 9.5 ppm and −58.8 ppm, which means that S²⁻/Cl⁻ ion is substituted. FIG. 9 is a graph showing a difference from the case by low temperature synthesis in comparison with FIG. 8. In the peaks for the precursors of FIGS. 9(a) and (b), it can be confirmed that the PS₄³⁻ structure is not well formed and substitution of S²⁻/Cl⁻ ions occurs less even after heat treatment. In addition, it can be confirmed that the peak is shifted to an up-field in FIG. 9(b), and the intensity of the peak appears small in the range of 58.8 ppm in FIG. 9(c). Overall, despite the short synthesis time, it can be seen that the anion substitution is well performed and the azirodite structure is well formed compared to the case of synthesizing by low temperature synthesis.

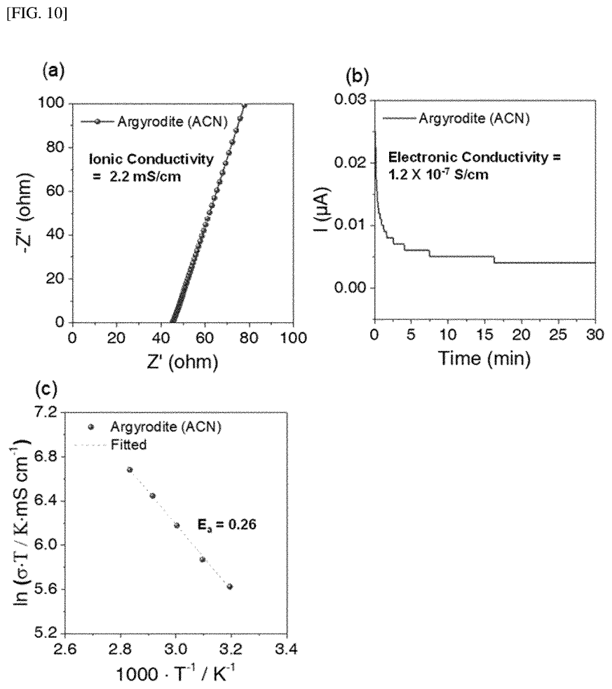

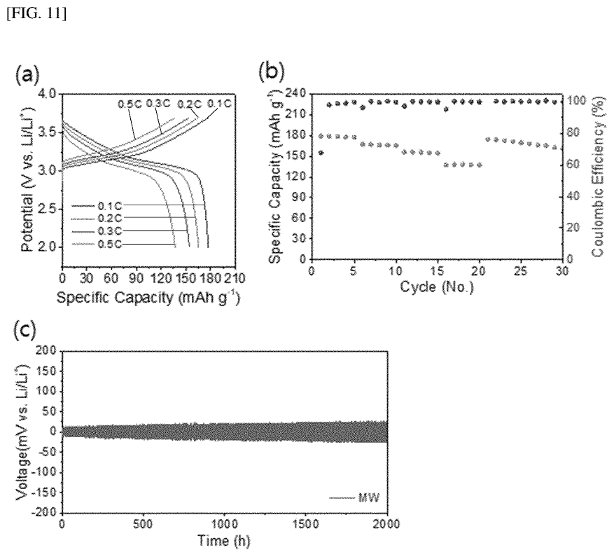

FIGS. 10 and 11 are results of manufacturing a battery using the manufactured solid electrolyte and analyzing characteristics thereof.

It can be seen that the ionic conductivity is 2.2 mS/cm in FIG. 10(a), and the electrical conductivity is 1.2×10⁻⁷ S/cm in FIG. 10(b). FIG. 10(c) shows the results of measuring the ionic conductivity according to temperature and calculating the activation energy using the Arrehenius plot. The higher the temperature, the better the ionic conductivity, and the activation energy was calculated as 0.26 eV.

FIG. 11 illustrates a galvanostatic charge/discharge curve of a battery. In FIGS. 11(a) and (b), the batteries had capacities of 177.2, 165.2, 154.3, and 137.2 mAh/g at 0.1, 0.2, 0.3, and 0.5 C (1 C=180 mAh/g), respectively. In addition, as a result of the symmetric cell analysis in FIG. 11(c), the interface stability with lithium metal was exhibited even for a long time of 2000 hours or more.

### 2. Examples 1-2 to 1-4

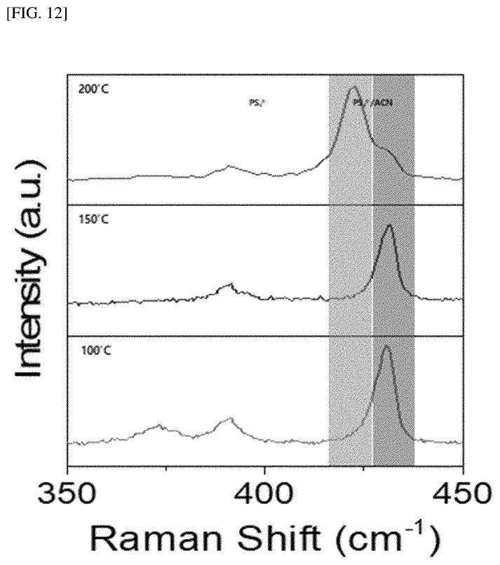

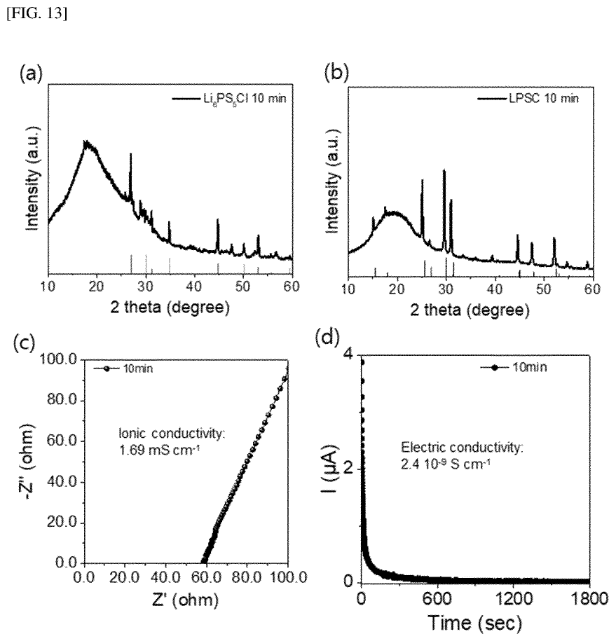

Whether the precursor was formed was observed by adjusting the final temperature and maintenance time in the precursor formation step of Example 1-1, and the results are shown in FIGS. 12 and 13.

FIG. 12 illustrates Raman spectroscopy confirming whether a precursor is synthesized after setting a final temperature differently and maintaining the final temperature for 10 minutes after reaching the final temperature. The peak at 428.5 cm⁻¹ is the peak indicating the binding state of PS₄³⁻ and acetonitrile molecules, and the peak at ˜418 cm⁻¹ is the peak indicating only the formation of PS₄³⁻ Therefore, it can be confirmed that an independent PS₄³⁻ structure is formed as the temperature increases.

FIG. 13 shows analysis results of precursors formed after setting the maximum temperature to 200° C. and maintaining the same for 10 minutes and argyrodite crystals obtained by heat-treating the same. FIG. 13(a) shows the XRD of the precursor, and FIG. 13(b) shows the XRD of the argyrodite crystals heat-treated, and even when the precursor is maintained at the maximum temperature for 10 minutes, it can be confirmed that the structure of PS₄³⁻ is also formed in the precursor, and the argyrodite crystals are formed by heat-treating it. FIG. 13(c) shows that the argyrodite crystals have an ionic conductivity of 1.69 mS/cm. FIG. 13(d) shows that the argyrodite crystals have an electrical conductivity of 2.4×10⁹ mS/cm. Therefore, it can be confirmed that although the time for maintaining the maximum temperature is less than that of Example 1-1, there is no significant difference in conduction characteristics from Example 1-1.

### 3. Examples 1-5

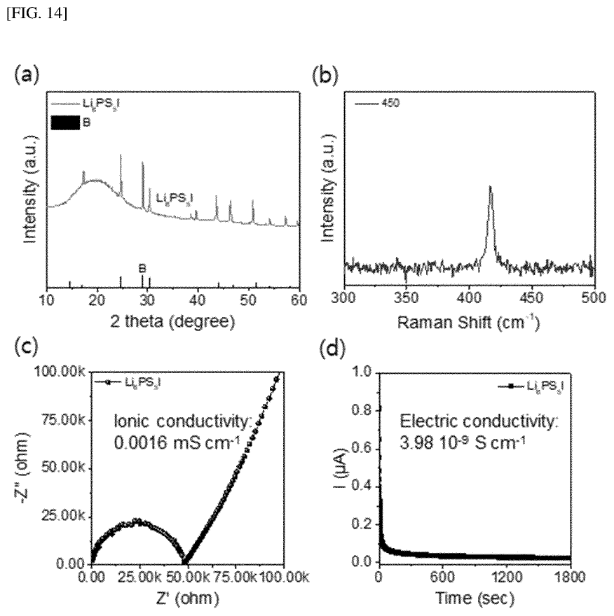

FIG. 14 illustrates synthesis of azirodite crystals using iodine (I) as a halogen element, and the characteristics thereof.

FIGS. 14(a) and (b) are XRD and Raman spectroscopic graphs of argyrodite crystals, and show peaks similar to the results in Example 1-1, indicating that argyrodite crystals were formed. FIG. 14(c) shows that the ionic conductivity of the argyrodite crystal is 0.0016 mS/cm, and FIG. 14(d) shows that the electrical conductivity of the argyrodite crystal is 3.98×10⁻⁹ S/cm.

Therefore, it can be confirmed that azirodite crystals are successfully synthesized even when iodine (I) is used.

### Experimental Example 2

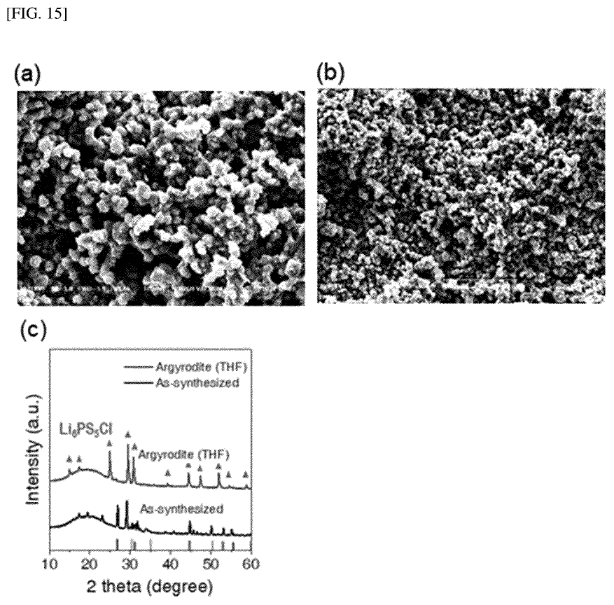

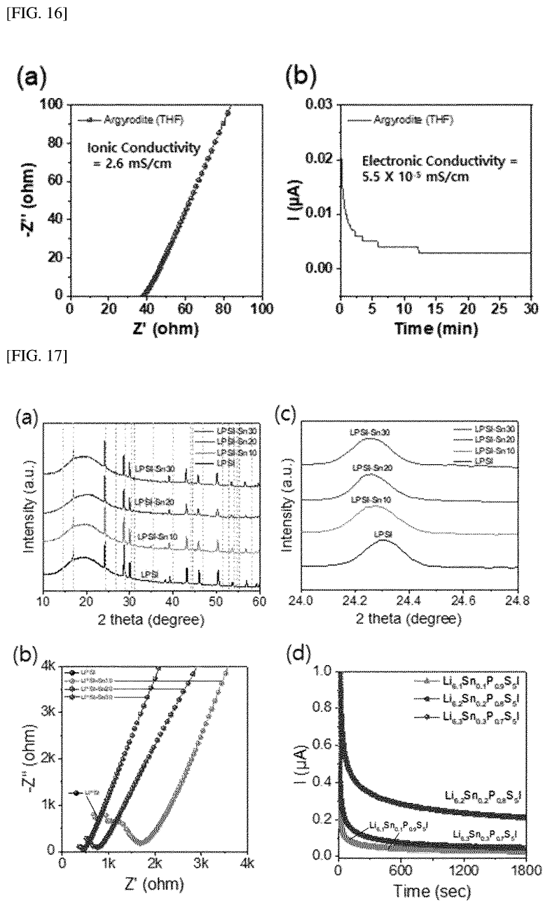

The argyrodite crystals synthesized in Example 2 and the prepared battery were analyzed and shown in FIGS. 15 and 16.

FIGS. 15(a) and (b) show SEM images of azirodite crystals synthesized using tetrahydrofuran (THF) solvent. It can be seen that crystals are well formed as in the case of using acetonitrile as a solvent.

FIG. 15(c) shows the results of XRD analysis immediately after the synthesis (that is, precursor, lower) and after the heat treatment (upper), and it can be confirmed that azirodite crystals are formed as peaks different from those of the precursor appear after the heat treatment.

In addition, in FIG. 16, it can be confirmed that the ion conductivity of the battery including the solid electrolyte synthesized using THF as a solvent is 2.6 mS/cm (FIG. 16(a)), and the electrical conductivity thereof is 5.5×10⁻⁶ S/cm (FIG. 16(b)).

### Experimental Example 3

Properties of a solid electrolyte prepared by substituting positions of P, S, and a halogen element with other elements in Example 3 were analyzed.

### 1. Examples 3-1 to 3-3

In Example 1-5, an argyrodite crystal in which a portion of a phosphorus (P) site is substituted with tin (Sn), and a battery using the same were manufactured, and properties thereof are shown in FIG. 17.

FIG. 17(a) shows the XRD results for each example, and shows that the same peak appears regardless of the substitution or content of tin, and argyrodite crystals are stably formed. However, when the tin is substituted, the peak of about 2θ=24.3 is shifted in FIG. 17(b). The reason for this shift is that since Sn(1.40 Å) has a larger ion radius than P(1.10 Å), the volume of the entire unit cell is increased. In addition, lithium ions (Li+) additionally fill vacancies generated by substituting tin (Sn), which is a tetravalent cation instead of phosphorus (P), which is a pentavalent cation, and thus the amount of lithium ions in the crystal structure increases, thereby increasing ionic conductivity. FIGS. 17(c) and 17(d) show the ionic conductivity and the electrical conductivity of each of Examples, which are summarized in Table 3. The ionic conductivity was improved compared to the case where tin was not substituted, and in particular, the ionic conductivity increased as the degree of substitution of tin increased.

TABLE 3

| | Ionic conductivity | Electrical conductivity |
|---|---|---|
| | (mS/cm) | (mS/cm) |
| Examples 1-5 | 0.0016 | 3.98 × 10⁻⁹ |
| Example 3-1 | 0.03 | 6.7 × 10⁻⁷ |
| Example 3-2 | 0.1 | 3.2 × 10⁻⁵ |
| Example 3-3 | 0.18 | 8.0 × 10⁻⁶ |

### 2. Example 3-4

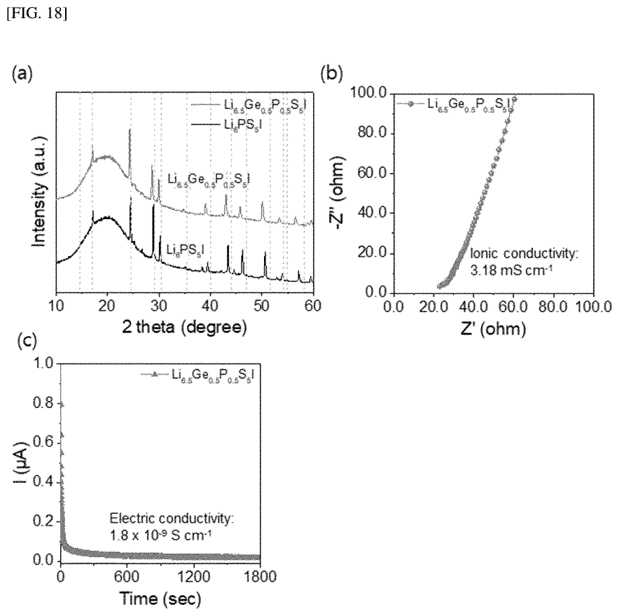

FIG. 18 illustrates an argyrodite crystal in which a portion of a phosphorus (P) site is substituted with germanium (Ge) in Example 1-5, and characteristics of a battery using the same.

FIG. 18(a) compares the results of XRD with those of Example 1-5, and it can be confirmed that azirodite crystals were formed as the peaks appear almost similar to each other even when substituted with germanium. FIG. 18(b) and FIG. 18(c) show the ionic conductivity and electrical conductivity of the battery, and show 3.18 mS/cm and 1.8×10⁻⁹ S/cm, respectively. It may be confirmed that the ionic conductivity is improved when germanium is substituted.

The present invention also relates to a method for manufacturing same. Examples 3-5 and 3-6 are provided

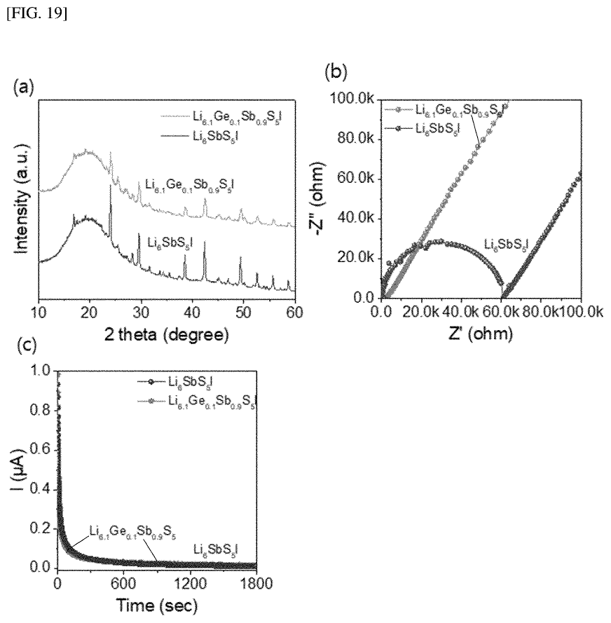

FIG. 19 illustrates an argyrodite crystal in which the sites of phosphorus (P) are substituted with antimony (Sb) and germanium (Ge) in Example 1-5, and characteristics of a battery using the same.

FIG. 19(a) shows that the two peaks are similar to each other when the peaks are XRD peaks and are substituted with only antimony and when antimony and germanium are substituted together. FIGS. 19(b) and (c) are graphs showing the ionic conductivity and electrical conductivity of the battery, and the results are shown in Table 4. In both cases, it may be confirmed that the ionic conductivity is improved when germanium is substituted.

TABLE 4

| | Ionic conductivity | Electrical conductivity |
|---|---|---|
| | (mS/cm) | (S/cm) |
| Examples 3-5 | 0.001 | 1.6 × 10⁻⁹ |
| Examples 3-6 | 0.03 | 1.4 × 10⁻⁹ |

Those skilled in the art to which the present invention pertains will be able to understand that the present invention may be embodied in other specific forms without changing the technical spirit or essential features thereof. Therefore, it should be understood that the examples described above are exemplary and not restrictive in all aspects. The scope of the present invention is indicated by the scope of a patent claim to be described later rather than the detailed description, and it should be interpreted that all changes or modifications derived from the meaning and scope of the scope of the patent claim and the equal concept thereof are included in the scope of the present invention.

1. A method for preparing a sulfide-based solid electrolyte for a lithium secondary battery, comprising the steps of:
preparing a reaction solution by dissolving a first compound containing lithium, a second compound containing one or more M elements, a third compound containing one or more chalcogen elements, and a fourth compound containing one or more halogen elements in a polar solvent;
forming a precursor by rapidly raising the temperature of the reaction solution;
drying the precursor to remove a residual solvent and select a solid material; and
heat-treating the solid material with an inert gas to crystallize the solid material and form an azirodite crystal structure,
wherein the M element is at least one of P, Sn, Sb, As and Ge, and
the azirodite crystal satisfies the chemical formula of Equation 1, and [Equation 1]
LiₐM_{b}A_{c}X_{d}
In Equation 1, 5≤a≤7.5, 0.5≤b≤1.5, 4≤c≤6, and 0.5≤d≤2. In Equation 1, M is at least one of P, Sn, Sb, As, and Ge. A is at least one of S, Se, and Te, and X is at least one of Cl, Br, and I.

2. The method for preparing a sulfide-based solid electrolyte for a lithium secondary battery of claim 1,
wherein the argyrodite crystal structure has peaks at diffraction angles of 2θ at 2θ=15°±0.5°, 17.5°±0.5°, 25°±0.5°, 29.5°±0.5°, and 30.9°±0.5° in an XRD spectrum using a CuKα ray, and the peaks at 2θ=15°±0.5° and 17.5°±0.5° are generated after heat treatment.

3. The method for preparing a sulfide-based solid electrolyte for a lithium secondary battery of claim 1,
wherein the polar solvent is polar aprotic, and the polar solvent comprises at least one of tetrahydrofuran, acetonitrile, ethyl pentanoate, ethyl acetate, 1,2-dimethoxyethane (1,2-dimethoxyethane), dimethyl carbonate, methyl propyl ketone, N-methylformamide, dimethyl sulfoxide, propylene carbonate, dichloromethane, N-methylmorpholine, 1,2-dimethoxyethane (1,2-dimethoxyethane), acetone, anhydrous hydrazine, pyridine, and anisole.

4. The method for preparing a sulfide-based solid electrolyte for a lithium secondary battery of claim 1,
wherein the precursor formed in the forming of the precursor is a compound of Equation 2, and the compound of Equation 2 is present even after the heat treatment
MA₄³⁻
Here, M is at least one of P, Sn, Sb, As and Ge, and A is at least one of S, Se and Te.

5. The method for preparing a sulfide-based solid electrolyte for a lithium secondary battery of claim 1,
wherein, in the forming of the precursor, a start temperature is 0° C. to 50° C., a temperature is increased at a rate of 20° C./min to 250° C./min, and a final temperature is 70° C. to 300° C.

6. The method for preparing a sulfide-based solid electrolyte for a lithium secondary battery of claim 1,
wherein the forming of the precursor is maintained for 1 minute to 12 hours after reaching a final temperature.

7. The method for preparing a sulfide-based solid electrolyte for a lithium secondary battery according to claim 1,
wherein in the heat-treating to form an argyrodite crystal structure, the heat-treating is performed at a starting temperature of 0° C. to 200° C., a temperature is increased at a rate of 2° C./min to 100° C./min, and a final temperature of 400° C. to 600° C.

8. The method for preparing a sulfide-based solid electrolyte for a lithium secondary battery of claim 1,
wherein an average particle diameter of the argyrodite crystal is 0.5 μm to 20 μm.

9. A sulfide-based solid electrolyte for a lithium secondary battery, which is the sulfide-based solid electrolyte prepared according to claim 1 and satisfies the chemical formula 1 of Equation 1; Equation 1
LiₐM_{b}A_{c}X_{d}
In Equation 1, 5≤a≤7.5, 0.5≤b≤1.5, 4≤c≤6, and 0.5≤d≤2. In Equation 1, M is at least one of P, Sn, Sb, As, and Ge. A is at least one of S, Se, and Te, and X is at least one of Cl, Br, and I.

10. The sulfide-based solid electrolyte for a lithium secondary battery according to claim 9, wherein the electrical conductivity is 10⁻¹⁰ S/cm to 10⁻² S/cm.

11. The sulfide-based solid electrolyte for a lithium secondary battery according to claim 9, wherein the ionic conductivity is 10⁻⁹ mS/cm to 20 mS/cm.

12. The sulfide-based solid electrolyte for a lithium secondary battery of claim 9,
wherein the sulfide-based solid electrolyte has peaks at diffraction angles 2θ at 2θ=15°±0.5°, 17.5°±0.5°, 25°±0.5°, 29.5°±0.5°, and 30.9°±0.5° in an XRD spectrum using a CuKα ray, and wherein the peaks at 2θ=15°±0.5° and 17.5°±0.5° are generated after heat treatment.

13. The sulfide-based solid electrolyte for a lithium secondary battery according to claim 9, wherein the argyrodite crystal structure is represented by the following Equation 5, and the sulfide-based solid electrolyte for a lithium secondary battery comprises a peak of 131.8±0.5 (P 2p3/2) and 132.7±0.5 (P 2p1/2) eV, which mean a P—S bond in the PS4³⁻ structure, in the P 2p spectrum, and a peak of 161.6±0.5 (P 2p3/2) and 162.5±0.5 (P 2p1/2) eV, which mean a P—S—Li bond in the PS4³⁻ structure, in the S 2p spectrum, in an X-ray photoelectron spectroscopy (XPS) analysis of the argyrodite crystal structure after heat treatment with the precursor; Equation 5
LiₐPS₅X_{d}
In Equation 5, 5≤a≤7.5, 0.5≤d≤2, and X are at least any one of Cl, Br, and I.

14. The sulfide-based solid electrolyte for a lithium secondary battery according to claim 9, wherein the argyrodite crystal structure is represented by the following Equation 6, and ionic conductivity increases so that b1 is increased; Equation 6
LiₐP_{(1-b1)}Sn_{b1}S₅X_{d}
In Equation 6, 5≤a≤7.5, 0.1≤b1≤1.0, 0.5≤d≤2, and X are at least one of Cl, Br, and I.

15. The sulfide-based solid electrolyte for a lithium secondary battery according to claim 9, wherein the argyrodite crystal structure is represented by the following Equation 7, and ionic conductivity increases so that b1 is increased; Equation 7
LiₐP_{(1-b1)}Ge_{b1}S₅X_{d}
In Equation 7, 5≤a≤7.5, 0.1≤b1≤1.0, 0.5≤d≤2, and X are at least any one of Cl, Br, and I.

16. The sulfide-based solid electrolyte for a lithium secondary battery according to claim 9, wherein the argyrodite crystal structure is represented by the following Equation 8, and ionic conductivity increases so that b1 is increased; Equation 8
LiₐSb_{(1-b1)}Ge_{b1}S₅X_{d}
In Equation 8, 5≤a≤7.5, 0≤b1≤1.0, 0.5≤d≤2, and X are at least any one of Cl, Br, and I.
